(19) United States
(12) Patent Application Publication
(10) Pub. No.: US 2008/0042109 A1
(43) Pub. Date: Feb. 21, 2008

(54) Mineral-enhanced computer component fabrication system and method

(76) Inventors: Paul N. Walker, Houston, TX (US); Mark S. Tracy, Houston, TX (US); Jeffrey A. Lev, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/491,618

(22) Filed: Jul. 24, 2006

(51) Int. Cl. H01B 1/24

(52) U.S. Cl. 252/511

(57) ABSTRACT

A computer device comprises a base member having a top cover couplable to a housing, the top cover formed using a mineral-enhanced resin mixture.

### BACKGROUND OF THE INVENTION

Many structural components of computer devices are fabricated by an injection molding process. However, as the size of the molded components decreases (e.g., reduced thickness, width and/or length), it is difficult to maintain a desired flatness of the component and/or desired rigidity/strength. This is especially difficult when using in-mold lamination (“IML”) or in-mold decoration (“IMD”) processes which incorporate a liner in the mold to enhance the aesthetic appearance of the structural component.

### BRIEF DESCRIPTION OF THE DRAWINGS

For a more complete understanding of the present invention, and the objects and advantages thereof, reference is now made to the following descriptions taken in connection with the accompanying drawings in which:

FIG. 1 is a diagram illustrating a computer device employing an embodiment of a mineral-enhanced top cover and display bezel in accordance with the present invention.

### DETAILED DESCRIPTION OF THE DRAWINGS

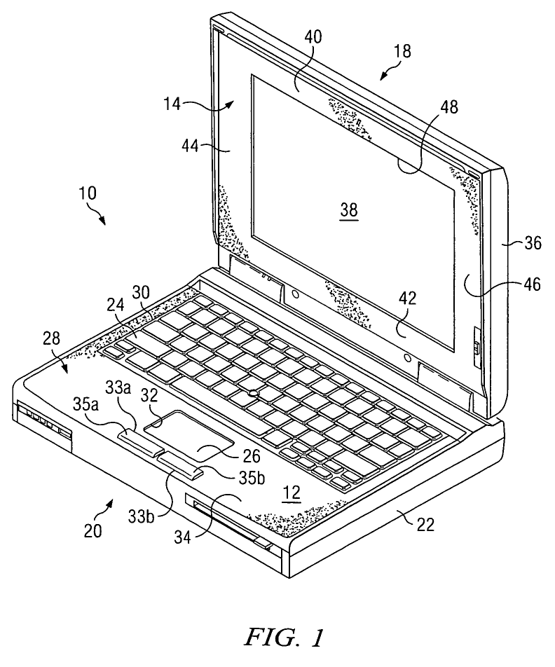

The preferred embodiments of the present invention and the advantages thereof are best understood by referring to FIG. 1 of the drawings, like numerals being used for like and corresponding parts of the drawings.

FIG. 1 is a is a diagram illustrating an embodiment of a computer device 10 employing a mineral-enhanced resin-based top cover 12 and display bezel 14 formed in accordance with an embodiment of the present invention. In the embodiment illustrated in FIG. 1, computer device 10 comprises a notebook or laptop computer having a display member 18 rotatably coupled to a base member 20; however, it should be understood that computer device 10 may comprise any type of computer device 10 such as, but not limited to, a desktop personal computer, tablet personal computer, laptop computer, gaming device, a handheld computing device, or any other type of portable or non-portable computer device.

In the embodiment illustrated in FIG. 1, base member 20 comprises a housing 22 configured to receive and/or otherwise support components such as a keyboard 24, a touchpad 26, and various internal components of the computer device 10 (e.g., a central processing unit, cooling unit, etc.). In the embodiment illustrated in FIG. 1, top cover 12 comprises a bexel for keyboard 24. However, it should be understood that the bezel for keyboard 24 is not limited to surrounding and/or otherwise being a faceplate for only keyboard 24 (e.g., other non-keyboard 24 buttons, lights, or other elements may also extend through or be bounded by the bezel). Top cover 12 is couplable to housing 22 to enclose the portion of housing facing upwardly (i.e., toward a user when in an open position and/or toward display member 18 when computer device 10 is in a closed position). In the embodiment illustrated in FIG. 1, top cover 12 comprises a working surface 28 having an opening 30 sized to enable keyboard 24 to be disposed therein and/or therethrough, an opening 32 sized to enable touchpad 26 to be disposed therein and/or therethrough, and openings 33a and 33b to enable push buttons 35a and 35b (and/or a wrist support) to be disposed therein and/or therethrough. It should be understood that top cover 12 may be configured having any size, shape and/or number of openings to accommodate placement of various elements of computer device 10.

In the embodiment illustrated in FIG. 1, display member 18 comprises a housing 36 configured to receive and/or otherwise support a display screen 38 and other internal components of computer device 10. Display bezel 14 is couplable to housing 36 to enclose the portion of housing 36 facing outwardly (i.e., toward a user when in an open position and/or toward base member 20 when computer device 10 is in a closed position). In the embodiment illustrated in FIG. 1, display bezel 14 comprises a top surface 40, a bottom surface 42 and a pair of side surfaces 44 and 46 that define an opening 48 to enable viewing of display screen 38.

Preferably, top cover 12 and bezel 14 are fabricated by injection molding using a resin such as, but not limited to, a blend of polycarbonate and acrylonitrile butadiene styrene (“PC/ABS”). Embodiments of the present invention employ a predetermined amount of magnesium silicate hydroxide (Talc) mixed with the PC/ABS to improve flatness (e.g., to substantially reduce or eliminate the component from warping during manufacturing, especially in instances where the component is thin), to improve impact strength and rigidity of the component, to reduce shrinkage, to reduce the manufacturing cycle times of the component (e.g., to reduce the time required to fabricate the component due to increased rate of hardening of the resin), and to increase the accuracy in which each component is fabricated (e.g., the increased repeatability of fabricating components with minimal or no dimensional inconsistencies sometimes caused by the component shrinking). Preferably, the resin mixture comprises fifteen percent (15%) by volume Talc (i.e., precisely or approximately 15%); however, it should be understood that a greater or lesser amount of Talc may be mixed with the PC/ABS to obtain the desired structural characteristics. In addition, embodiments of the present invention employ a predetermined amount of glass and/or carbon mixed with the PC/ABS (and also PC/ABS/Talc mixture) to obtain the desired structural characteristics. Accordingly, components such as top cover 12 and display bezel 14 may be manufactured substantially thinner without compromising the overall stability of the part (e.g., less susceptible to warping, shrinking, etc., while providing increased strength, etc.).

Preferably, top cover 12 and display bezel 14 are injection-molded using an in-mold lamination (“IML”) process or an in-mold decoration process (“IMD”). The IML and IMD processes comprise inserting a liner inside the injection mold cavity followed by injection of the resin/Talc mixture into the cavity. The resin melts and adheres to the inner side of the liner, thereby producing a part with the final finish defined by the decorative liner. After the resin melts and cools, top cover 12/display bezel 14 is removed from the mold for further processing and/or coupling to computer device 10. It should be understood that other methods of manufacturing are available, such as traditional injection molding (e.g., without IML or IMD).

Thus, embodiments of the present invention enable the manufacture of structural components with improved flatness (e.g., to substantially reduce or eliminate the component from warping during manufacturing, especially in instances where the component is thin), with improved impact strength and rigidity and with minimal or no shrinkage. Further, embodiments of the present invention reduce the manufacturing cycle times of each component (e.g., reduce the time required to fabricate the component due to increased rate of hardening of the resin), and increase the accuracy in which each component is fabricated (e.g., increased repeatability of fabricating components with minimal or no dimensional inconsistencies).

What is claimed is:

1. A computer device comprising:
a base member having a top cover couplable to a housing, the top cover formed using a mineral-enhanced resin mixture.

2. The computer device of claim 1, wherein the resin mixture comprises a blend of polycarbonate and acrylonitrile butadiene styrene (“PC/ABS”)

3. The computer device of claim 1, wherein the resin mixture comprises magnesium silicate hydroxide.

4. The computer device of claim 1, wherein the resin mixture comprises fifteen percent (15%) by volume magnesium silicate hydroxide.

5. The computer device of claim 1, further comprising a display member coupled to the base member, the display member having a bezel formed using a mineral-enhanced resin mixture.

6. The computer device of claim 5, wherein the bezel is formed from a resin mixture having fifteen percent (15%) magnesium silicate hydroxide.

7. A computer device comprising:
a housing means and a cover means coupled thereto, the cover means formed using a mineral-enhanced resin mixture.

8. The computer device of claim 7, wherein the base means is formed using a blend of polycarbonate and acrylonitrile butadiene styrene (“PC/ABS”).

9. The computer device of claim 7, wherein the resin mixture comprises magnesium silicate hydroxide.

10. The computer device of claim 7, wherein the resin mixture comprises fifteen percent (15%) by volume magnesium silicate hydroxide.

11. The computer device of claim 7, further comprising a display means having a bezel means supporting a screen means, the bezel means formed using a mineral-enhanced resin mixture.

12. A method of manufacturing a computer device, comprising:
providing a housing and a top cover coupled thereto, the top cover formed using a mineral-enhanced resin mixture.

13. The method of claim 12, further comprising forming the top cover with a resin mixture comprising a mineral-enhanced blend of polycarbonate and acrylonitrile butadiene styrene (“PC/ABS”).

14. The method of claim 12, further comprising forming the top cover with a resin mixture comprising magnesium silicate hydroxide.

15. The method of claim 12, further comprising forming the top cover with a resin mixture comprising fifteen percent (15%) magnesium silicate hydroxide.

16. The method of claim 12, further comprising providing a display member coupled to the base member, the display member having a bezel formed from a mineral-enhanced resin mixture.

17. The method of claim 16, further comprising forming the bezel using a resin mixture comprising magnesium silicate hydroxide.

18. The method of claim 16, further comprising forming the bezel using a resin mixture comprising fifteen percent (15%) by volume magnesium silicate hydroxide.

19. A computer device comprising:
a display member having a bezel supporting a display screen, the bezel formed using a mineral-enhanced resin mixture.

20. The computer device of claim 19, wherein the bezel is formed using a resin mixture comprising magnesium silicate hydroxide.

21. The computer device of claim 19, further comprising a base member coupled to the display member and having a top cover, the top cover formed using a mineral-enhanced resin mixture.
